(19) United States
(12) Patent Application Publication
(10) Pub. No.: US 2013/0096940 A1
(43) Pub. Date: Apr. 18, 2013

(54) Free Medical Advice Via the Internet

(71) Applicant: Victor M. Hayes, Odessa, FL (US)

(72) Inventor: Victor M. Hayes, Odessa, FL (US)

(21) Appl. No.: 13/650,689

(22) Filed: Oct. 12, 2012

Related U.S. Application Data
(60) Provisional application No. 61/546,356, filed on Oct. 12, 2011.
(60) Provisional application No. 61/595,255, filed on Feb. 6, 2012.

(51) Int. Cl. G06Q 50/22

(52) U.S. Cl. 705/2

(57) ABSTRACT

An Internet site provides free medical advice to users. Accurate data collection and a summary of medical information will be constructed by using a combination of Virtual Resources. Each online interaction will be patient specific (unique) as each patient has a unique set of issues surrounding their medical problem/condition. The results will be displayed to patients with hyperlinks on medical terms. Once this medical summary of the data is provided, the system will calculate the statistical likelihood of diagnosis using a logic platform database. The logic of the program will improve over time because its interviewing skills will improve as it learns. Lines of questioning are based on Concept Maps (and/or another visual organization tool). The system will learn from its patients and that data will be reviewed and organized by groups of physicians. The system will also gain (medical) practice experience from the physicians involved in the website administration.

### RELATED APPLICATIONS

This patent application claims the benefit of and/or priority under 35 U.S.C. §119(e) to U.S. Provisional Patent Application Ser. No. 61/546,356 filed Oct. 12, 2011, entitled “Free Medical Advice Via the Internet” and U.S. Provisional Patent Application Ser. No. 61/595,255 filed Feb. 6, 2012, entitled “Free Medical Advice Via the Internet” the entire contents of each of which is specifically incorporated herein by this reference.

### BACKGROUND OF THE INVENTION

1. Field of the Invention

The present invention relates to the field of medical advice and, more particularly, to providing medical advice via the Internet.

2. Background Information

Medical information regarding almost every human condition, ailment, affliction and/or disease (collectively, condition) can be located on the Internet. Internet sites having medical dictionaries, diagrams, condition specific information as well as sites dedicated to a particular condition, conditions and/or medical area(s) or specialty are available mostly for free. This allows an individual to locate information regarding an individual or personal condition as well as for another.

While these Internet sites can provide good medical information, the individual must inherently perform a self diagnosis of the condition. Misdiagnosis, misinformation and/or insufficient information regarding the condition can pose a medical threat to the individual or other self-diagnosed individual. However due to the fact that such medical information is free, consulting Internet medical information is now becoming a first medical source for those seeking a medical diagnosis.

The alternative for the individual is to physically consult a medical professional. Due to current medical costs as well as socio and economic factors and/or considerations, people are now less likely to physically consult (i.e. in person) a medical professional about a particular condition.

Of course, it is generally preferable for an individual to physically see a medical professional in order to obtain patient specific medical advice about a particular condition and certainly in an emergency. However, due to various circumstances, factors and/or considerations, it is easier, faster for an individual to consult the Internet for medical information. Moreover, given that medical treatment is expensive and one may not have medical insurance, people more readily consult the Internet for medical information. Unfortunately, Internet sites only provide information about a particular condition or conditions and therefore cannot diagnose or provide accurate medical advice regarding an individual's particular condition. The individual must therefore self diagnose. Self diagnosis may lead to misdiagnosis which can have adverse consequences to the individual.

In view of the above, it would be desirable to provide accurate free medical advice to an individual via the Internet about an individual's specific condition.

The problems in the prior art addressed above, the desirables presented herein, and more are addressed by the present invention.

### SUMMARY OF THE INVENTION

A system and method provides honest medical advice for free to and for an individual via the Internet. This allows an individual to obtain medical advice regarding a probable diagnosis without the stress and wasteful cost of a physical medical consultation, diagnosis and advice.

The system and method may be implemented within a single, general free medical advice Internet site (e.g. freemedicaladvice.com or freespineadvice.com) that is knowledgeable regarding a plurality of medical conditions through data collection, databases, statistical probability analysis, and pattern recognition. The general free medical advice Internet site may include a plurality of separate free medical advice websites each one specific to a particular medical field or area such as, but not limited to, the spine (e.g. freespineadvice.com), orthopedics (e.g. freeorthoadvice.com), gynecology (e.g. freegynadvice.com), MVA (e.g. freemvaadvice.com), dermatology (e.g. freedermadvice.com) and urology (e.g. freeurologyadvice.com). Of course, other medical fields may be provided.

The system and method may be implemented without the single general free medical advice Internet site but rather with only the plurality of separate free medical advice Internet sites each one specific to a particular medical field or area. The plurality of separate free medical advice Internet sites are preferably, but not necessarily, linked, connected or otherwise associated with and to one another.

Each free medical advice Internet site provides an online virtual interaction between a patient (i.e. an individual visiting the Internet site) and an intelligent computer program capable of making complex medical decisions in the general and particular medial field or area. The intelligent computer program (ICP) provides 1) accurate data collection and summary of medical information using a combination of virtual resources including VIPD, VP and VIPE (described below), 2) a platform for logical interpretation of medical data, recognition of visual patterns within the data, and deducing the most statistical likelihood of diagnosis (SLD) based on information provided, and providing free advice on obtaining assistance for any condition, and to help an individual with condition problems to obtain the appropriate work-up and imaging, medication recommendations/precautions, therapy, alternative treatments, physician referrals and surgical recommendations if necessary. The Internet site may allow ratings on providers along with the cost of treatment. Discount cards for referrals may be provided for additional cost savings.

Each online interaction will be individual specific (unique) as each individual has a unique set of issues surrounding their medical problem: e.g. sex, age, duration of symptoms and past medical history.

The primary goal of these Internet sites is to provide free medical advice to all individuals worldwide with a medical condition, consonant with the particular Internet site, especially individuals with little or no means to otherwise obtain this help (e.g. uninsured/destitute/rural). Other goals of each Internet site are: 1) to obtain information about the individual's condition or disorder without the hassle, stress, time, and inconvenience of visiting a physician and/or other health care provider; 2) provide as much information about the particular condition(s) or disorder(s) as possible to the individual in “layman's” terms so they understand their problem, understand the diagnosis and recommended treatment options, understand the importance of such treatment and seek/implement the appropriate evaluation and management ASAP; 3) recognize patterns and calculate the statistical chance (% likelihood) of a diagnosis based on the lines of questions answered, store these patterns, and have physicians and/or other medical professional(s) modify the database on a regular (e.g. monthly) basis to improve treatments; 4) use the statistical likelihood of a diagnosis to drive the decision making process when it comes to treatment (i.e. the logic or Virtual Doctor Aspect of the program); 5) follow up with the individual to gather data on how well the technique works with a particular medical diagnosis, then expand this concept to other fields of medicine including but not limited to Dermatology, Internal Medicine, General Surgery, ENT, Urology, Vascular Surgery, OB/GYN, Pulmonary/Cardiology, ECT, etc.; 6) build the intelligent database over time as more physicians and medical professionals are involved in the program administrative functions, allowing the database to be used to standardize care and avoid unnecessary tests and procedures, as well as allow use by insurance carriers to justify ordering or not ordering tests (based on the statistical likelihood of a diagnosis); and 7) use information from the database to work with (and charge) health care insurance companies to drive down costs.

The primary the present system and method is an Internet site or website that will provide free medical advice to all individuals/patients worldwide with any medical disorder (especially individuals with little or no means to otherwise obtain this help). Accurate data collection and a summary of medical information will be constructed by using a combination of Virtual Resources including VIPD, VP and VIPE. Each online interaction will be patient specific (unique) as each patient has a unique set of issues surrounding their medical problem/condition, e.g. different sex, age, duration of symptoms, type of symptoms and past medical history. A NSSH will be a constructed based on the information above. This will be a concise medical summary (about 1 paragraph) of the patients VIPD, VIH, & VIPE and results will be displayed to patients with hyperlinks on medical terms for additional information. Once this medical summary of the data is provided, the system will calculate the SLD using the Logic Platform Database.

The Internet site program's administrative functions will allow groups of physicians to overseeing the Internet site and improve its diagnostic ability over time. The logic of the program will improve over time because its interviewing skills will improve as it learns. These administrators will be able to recognize patterns visually (rather than from a spread sheet) and change the lines of questioning based on Concept Maps (and/or another visual organization tool). These Concept Maps help a physician understand cause and effect relationships. By using Concept Maps, a physician can recognize and organize the information in logical and meaningful ways. Each Concept Map serves its own purpose for a particular diagnosis and will be adapted or interconnected to similar diagnoses easily. The system will learn from its patients and that data will be reviewed and organized by groups of physicians. The system will also gain (medical) practice experience from the physicians involved in the website administration.

### BRIEF DESCRIPTION OF THE DRAWINGS

The above mentioned and other features, advantages and object of this invention, and the manner of attaining them, will become apparent and the invention itself will be better understood by reference to the following description of an embodiment of the invention taken in conjunction with the accompanying drawings, wherein:

FIG. 1 is a representation of a system for providing free medical advice to a user via the Internet per the principles of the present invention;

FIG. 2 is a diagrammatic representation of a free medical advice platform implemented on a computer of the present system, particularly for logical interpretation of user medical data input to the system, recognition of visual patterns within the inputted user medical data, and deducing the most statistical likelihood of diagnosis based on the inputted user medical data;

FIG. 3 is an illustration of an exemplary Internet site for implementing the present free medical advice system, including an interactive virtual physician, a diagnosis section, and a rotating virtual body image that will show internal structures of the body once a pointing device hovers over a region of the body, and which also shows the internal structures that pertain to a diagnosis and which will help explain the diagnosis to the user in laymen's terms;

FIG. 4 is a diagram of an exemplary concept map as used by the present free medical advice platform; and

FIGS. 5A-C is a diagram of another exemplary concept map as used by the present free medical advice platform.

A description of the features, functions and/or configuration of the components depicted in the various figures will now be presented. It should be appreciated that not all of the features of the components of the figures are necessarily described. Some of these non discussed features as well as discussed features are inherent from the figures. Other non discussed features may be inherent in component geometry and/or configuration.

### DETAILED DESCRIPTION OF THE INVENTION

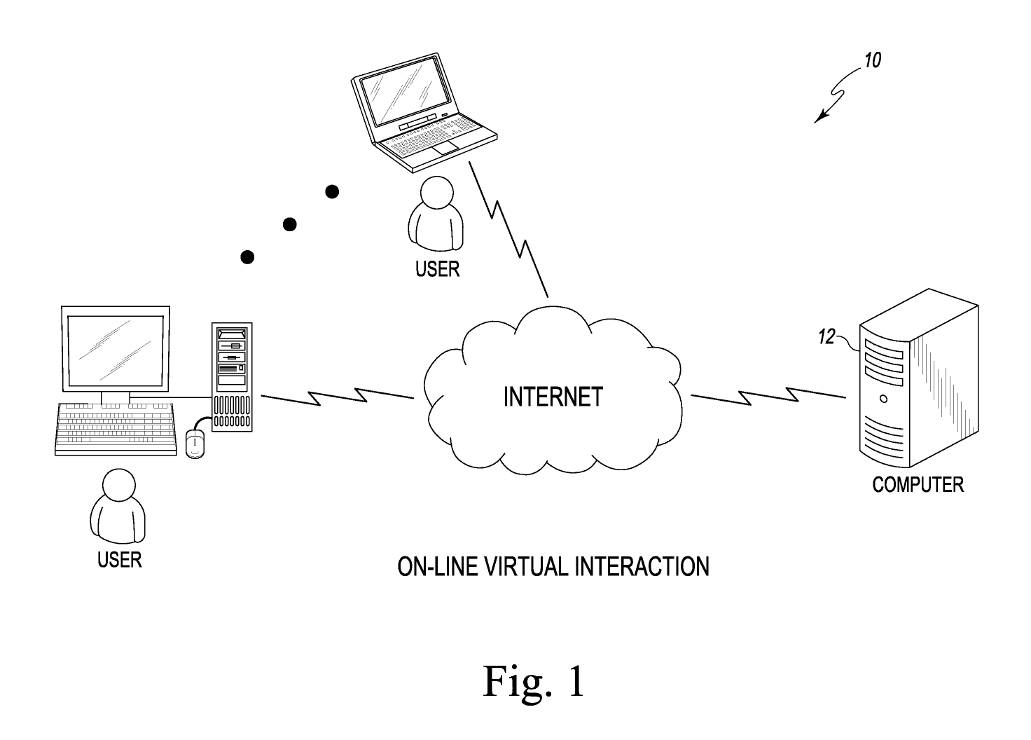

Referring to FIG. 1, there is shown an exemplary system, generally designated 10, for providing free medical advice to a user via the Internet per the principles of the present invention. The system 10 uses the Internet to allow users to access a free medical advice computer or server 12 in communication with the Internet housing a free medical advice platform per the principles of the present invention. Two users are shown connecting to the free medical advice computer/server 12. It should be understood that the depiction of one computer represents one or more computers, servers and the like necessary to carry out the present invention. For instance, one computer may host the free medical advice Internet site, while another may host the free medical advice logic or platforms. As such, the present invention will hereinafter be discussed with reference to the single computer 12. The free medical advice computer 12 implements the various programs, databases, logic, and other components as set forth herein.

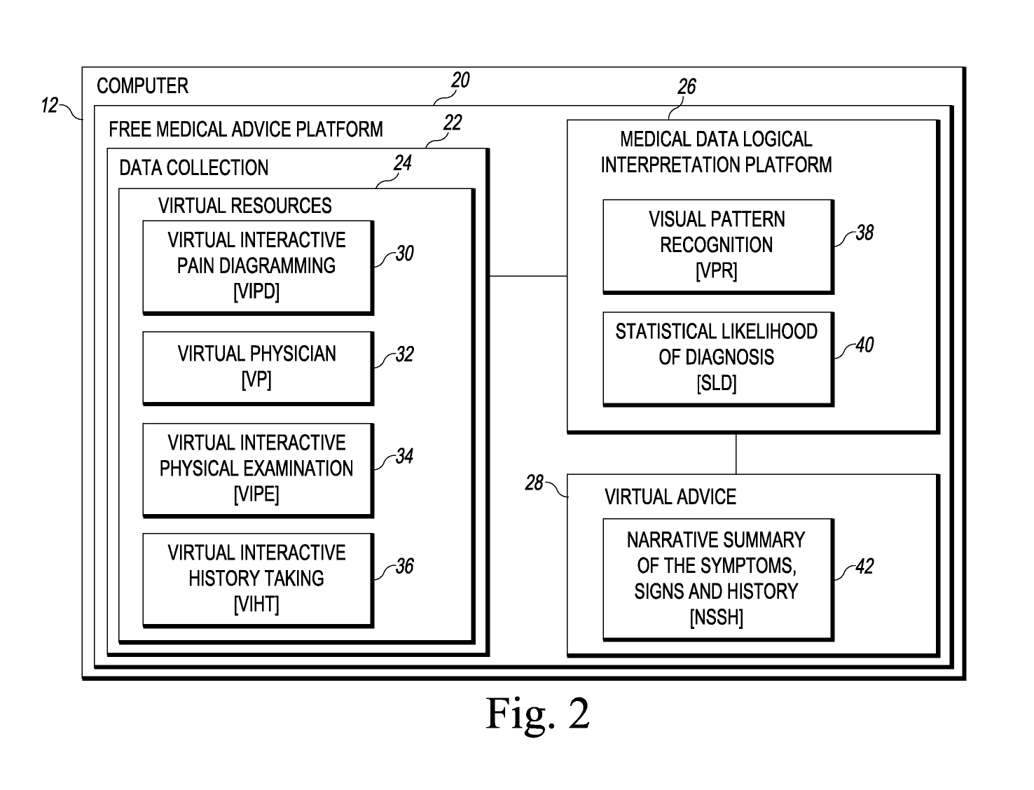

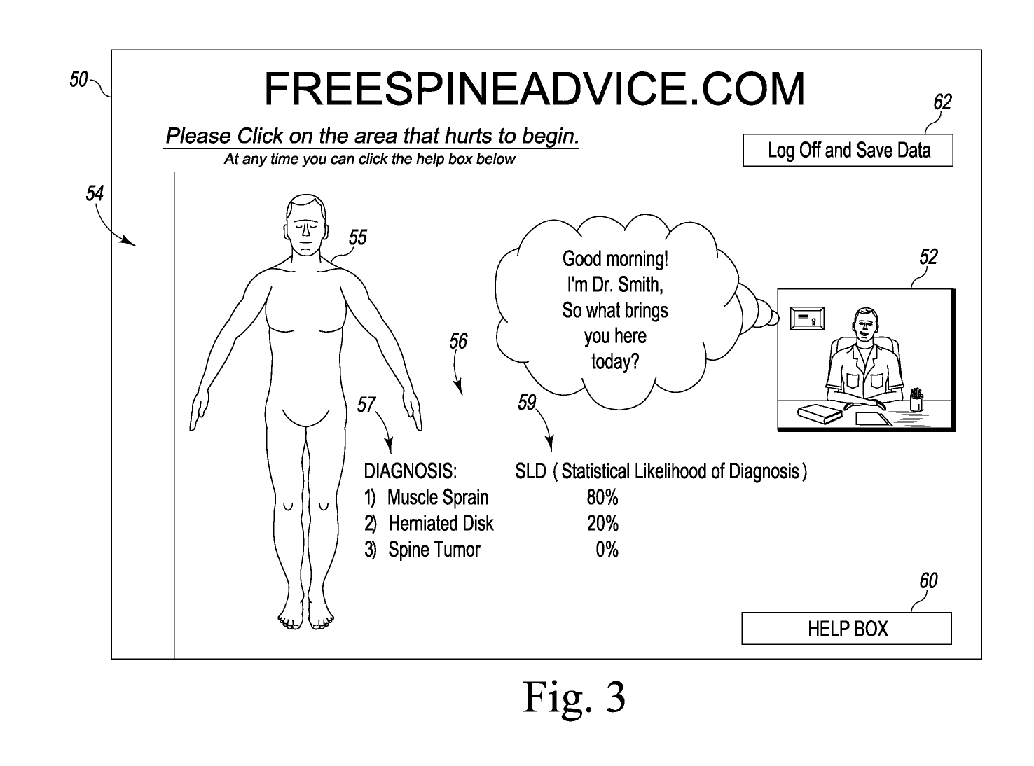

FIG. 2 depicts a diagram of the various programs, logic, and/or platforms 20 used by the present free medical advice computer 12 and particularly as implemented through an Internet site such as the Internet site “FREESPINEADVICE.COM” generally designated 50 illustrated in FIG. 3. The Internet site 50 is the gateway to and the end implementation vehicle for providing free medical advice via the Internet in accordance with the present principles. It should be appreciated that the FREESPINEADVICE.COM Internet site may consist of several pages or screens if desired. Therefore, while only a single page or screen of the FREESPINEADVICE.COM Internet site is shown, the FREESPINEADVICE.COM Internet site may have more than one page or screen. An exemplary system and method for providing free medical advice to and for an individual via the Internet via an all encompassing general medical knowledge Internet site will now be provided with respect to the medical condition being a spine disorder. It should be understood that the following is applicable to all of the present free medical advice Internet sites as described herein.

The free medical advice platform 20 includes data collection 22 to collect or obtain data from a user using the free spine advice Internet site 50. The Internet site 50 preferably, but not necessarily, requires a user to log onto the site. Data collection 22 includes various virtual resources 24 for presenting information to the user and collecting medical data from the user in order to provide medical advice and/or statistically determined diagnoses to the user. The virtual resources 24 includes a virtual interactive pain diagramming (VIPD) 30 that is configured to generate a virtual interactive pain diagram 54 (see FIG. 3) of a body 55, and a virtual physician (VP) 32 that is configured to generate a virtual physician 52 (see FIG. 3) that communicates with the user via text (such as shown in FIG. 3 where a user is being welcomed to the Internet site). Data collection 22 also includes virtual interactive physical examination (VIPE) 34 and virtual interactive history taking (VIHT) 36 both of which are configured to allow a user to interact with the VP 52 and the VIPD 54 by text inputted by the user and through the user pointing and clicking on the interactive body 55 of the VIPD 54 typically, but not necessarily, as asked, directed or guided by the VP 52. The VP 52 asks various questions of the user based on the data provided by the user via inputted text and the VIPD 54. The virtual body 55 may rotate to allow the user to employ a pointing device (e.g. a mouse) to select or point out an area, areas or particular body system, organ, bone, joint or the like as asked by the VP 52 or independently provided by the user as part of the data collection.

The free medical advice platform 20 also includes a medical data logical interpretation platform 26 that is configured to analyze the collected medical data. The medical data logical interpretation platform 26 includes visual pattern recognition (VPR) 38 that is configured to recognize patterns in the collected medical data, particularly with respect to all of the medical data collected by the site, in order to determine a diagnosis for the particular user per the medical information or data obtained from the user during their on-line session, and statistical likelihood of diagnosis (SLD) 40 configured to determine statistical likelihood of particular medical diagnoses based on the collected user medical data per directed questions or a line of questioning by the VP 52, VPR 38 and other logical programming of the free medical advice platform 22. The SLD 40 drives the decision making process from the logic (VP 52) of the free medical advice platform 20. The medical data logical interpretation platform 26 further includes virtual advice 28 that includes a narrative summary of the symptoms, signs and history (NSSH) of the user as determined by the logic of the free medical advice system 20.

The free spine advice Internet site 50 further provides help for the site that the user may access by clicking on the Help Box 60. Selecting the Help box 60 takes the user to another page or screen (not shown) that provides help to the user in the form of dialog between the user and the VP 52, frequently asked question and the like. Since the free spine Internet site 50 preferably, but not necessarily, uses a log-in system to access and use the site, the page 50 includes a Log Off and Save Data box 62 that logs off the user then saves the data associated with the particular user. Once the appropriate medical data and answers to the calculated series of medical questions asked by the VP 52, the system provides one or more diagnoses listed in order of their statistical likelihood of diagnosis (SLD). Particularly, the site 50 has a diagnosis section 56 where one or more diagnoses 57 are listed as predicted by the system logic as well as a percentage that the particular diagnosis is the likely medical condition (i.e. the Statistical Likelihood of Diagnosis—SLD 59).

One provision of the present system and method for providing free medical advice to and for an individual via the Internet is the accurate collection of data. The Internet site or website will have a splash or opening page consisting of the Virtual Interactive Pain Diagramming (VIPD) system. The VIPD will have a pointer to specify the area of pain and discomfort and this will subsequently drive the questioning on symptoms being experienced by a patient/client. The VIPD with be able to obtain the information about the (subjective) symptoms experienced by using a combination of both visual cues on a human model and questions being asked by a virtual physician located on the page. This data will be stored in the database and used to drive the patient history taking.

This VP 52 will perform a standard history just as a normal spine surgeon/physician would perform in his or her office, asking specific questions focused on obtaining the most likely diagnosis with the least amount of questions, directing the history and the patient/virtual doctor interaction to reduce the time of history taking. This will be called Virtual Interactive History (VIH). Age, sex, weight, height, duration and intensity/location of symptoms/signs, accurate medical history, current medications will all be some of the questions asked by the VIH. The VIH will key in on the patient signs (objective) frequently caused by a specific spine illness if this is suspected based on answers given to prior lines of questioning. The VIH program will NOT use a symptoms checker like WebMD does where a patient clicks on their symptoms. The Virtual interactive history taking program will be the driving force for steering the patient towards a particular diagnosis as efficiently as possible.

The VIPD and VIH will initiate the Virtual Interactive Physical Examination (VIPE) process. The VIPE process will consist of a series of simple physical exam maneuvers that will be performed by the patient within the confines of their home (to obtain the maximum amount of information about the patient's physical condition at the present time). These physical examination maneuvers will use videos, diagrams and visual cues to have these tests performed correctly. The patient will enter the results in a drop down menu.

Examples of the VIPE process are:

A diagram illustrating a straight leg raise test being performed by a doctor. Upon further questioning if the patient doesn't understand this, a video of a doctor examining a patient and performing a straight leg raise test will be shown. The diagram and the virtual doctor will explain positive findings and what to document with regards to results;

The patient is instructed to place their feet together, keep their knees straight and try to touch their toes. You should stop as soon as they start having any discomfort. How far can you bend over?

The VIPE may provide questions that may be answered by typing in a text box or selecting an appropriate response from a drop down menu. For instance, with regard to medical advice about a spine condition, the VIPE may ask the user to “Select the following Answer from the drop down menu: “How far can you bend over?” The user may select, for example, “Unable”.

These answers may elicit additional questions. The Virtual Physcian/Doctor may respond: “You can barely bend over, your condition seems severe, and we may need to refer you to a specialist immediately for a further evaluation. Take this Summary of your findings to one of the physicians of your choice listed below”

The Internet site 50 will provide a Narrative (Summary) of the Symptoms, Signs, and History (NSSH). The NSSH will be a concise medical summary (about 1 paragraph) of the patient's VIPD, VIH, & VIPE results will be displayed to patients with hyperlinks on medical terms for additional information. An arrow over a hyperlink will describe the word or series of words the term in layman's terms or with pictures/videos.

Example of an NSSH:

This patient is a 42-year-old male construction worker and heavy laborer. The patient has a long-standing history (>15 years) of 75% back pain (located over his lower lumbar region @ L4-L5) and 20% right >left lumbar sciatica symptoms (with numbness and pain but no weakness in his legs). His symptoms have dramatically worsened after he lifted a heavy box at work two weeks ago. The sciatica pain is radiating into his buttocks and travels down the back of the leg towards his feet with associated numbness (In the L5 Dermatome). Treatment wise, he has taken over the counter Anti-inflammatory medication (which mildly helped) but has not had formal physical therapy, Chiropractic therapy, alternative treatments, bracing, or other conservative care. The patient denies problems with balance, fine motor coordination, or spine related bowel or bladder symptomatology.

The patient will confirm the accuracy of the NSSH and edit areas of inaccuracy before signing off on the narrative summary. Once the Narrative Summary (NSSH) is accurate, the logic of the program will analyze all the information obtained and deduce the most common diagnosis and/or diagnoses (up to a set amount, e.g. 3).

The Internet site 50 thus includes the logical platform 20 for interpretation of medical data, the logical platform 50 consisting of a large database of typical questions asked by a spine (medical) expert and typical responses from patients. The types and sequence of the questions asked will be pulled from the Logic Database and will depend on the responses from the patient. A database will be initiated by a board certified (US) physician and/or specialist in the particular medical field/area based on the medical experience and expertise in treating the medical disorders. Other physicians and/or medical professionals will all be allowed to administrate the program adding knowledge/experience to the virtual doctor logic. The databases SLD (Statistical Likelihood of Diagnosis) function will become more efficient and accurate as the program recognizes and learns patterns of answers. These patterns will determine how the lines of questioning are organized and rearranged.

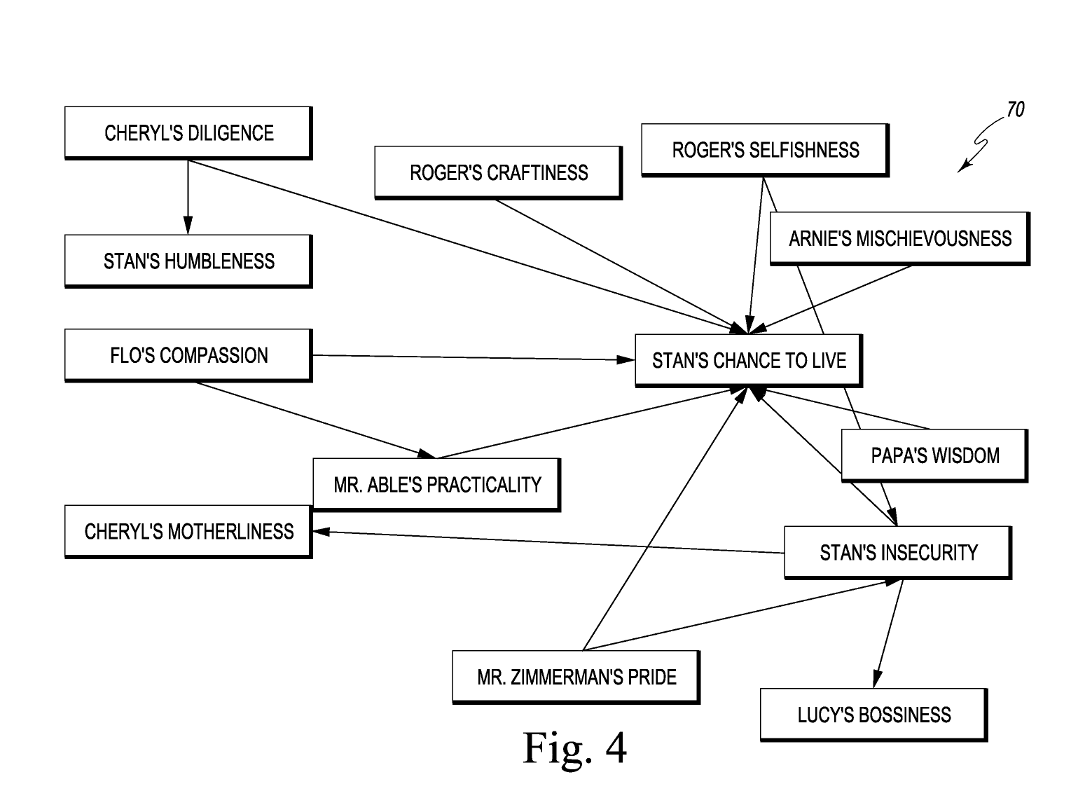

The program's administrative functions will allow groups of physicians to oversee the site and improve its diagnostic ability over time. The logic of the program will improve over time because its interviewing skills will improve as it learns which (groups) of questions arrive at a particular diagnosis faster than others. These administrators will be able to recognize patterns visually (rather than from a spread sheet) and change the lines of questioning based on concept maps (and/or another visual organization tool). These concept maps help a physician understand cause and effect relationships. By using concept maps, a physician can recognize and organize the information in logical and meaningful ways. Each concept map serves its own purpose for a particular diagnosis and can be adapted or interconnected to similar diagnoses easily (By dragging and interconnecting arrows). A sample concept map 70 is provided in FIG. 4 based on a fictitious novel.

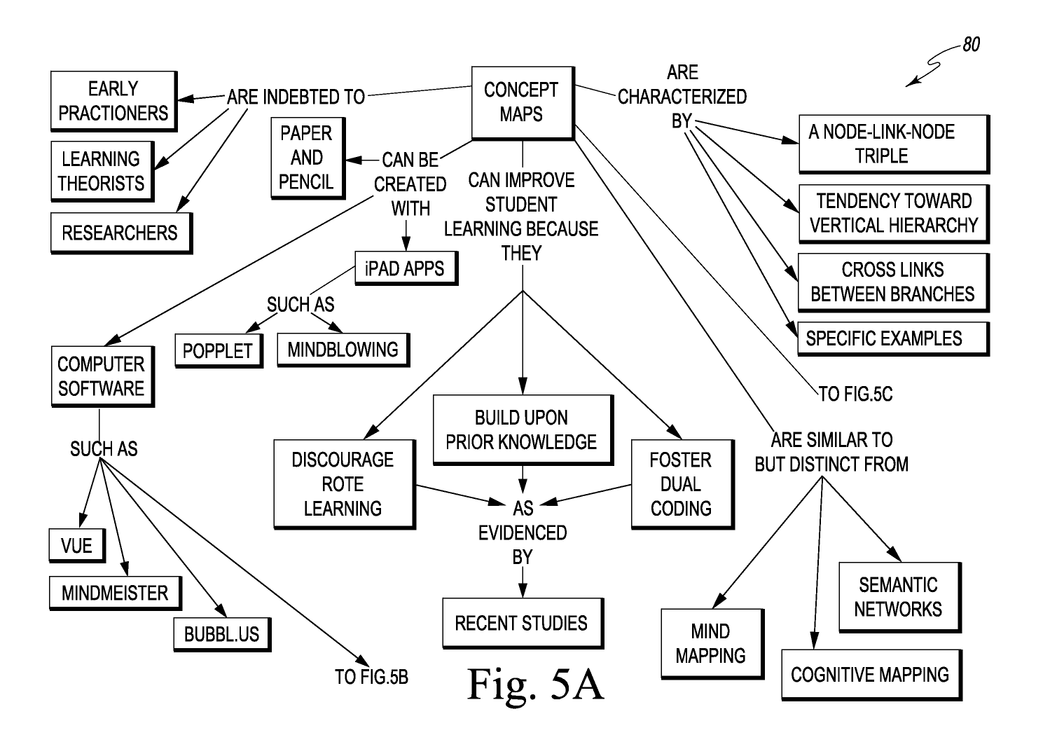

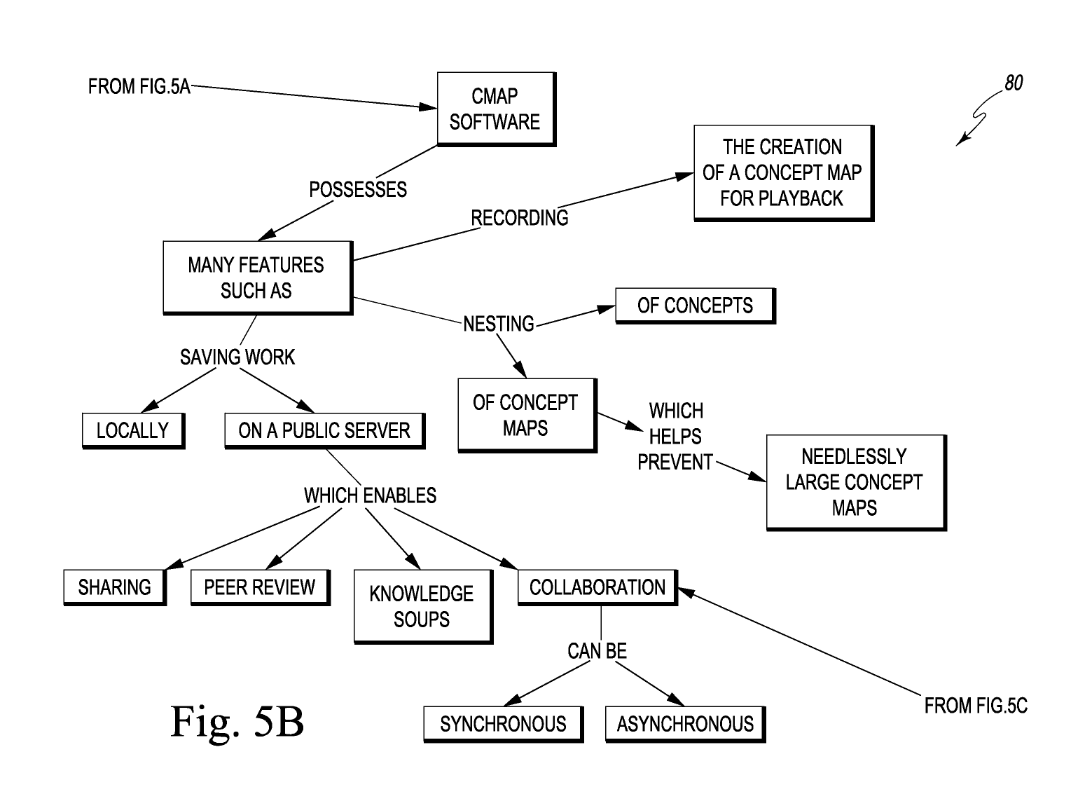

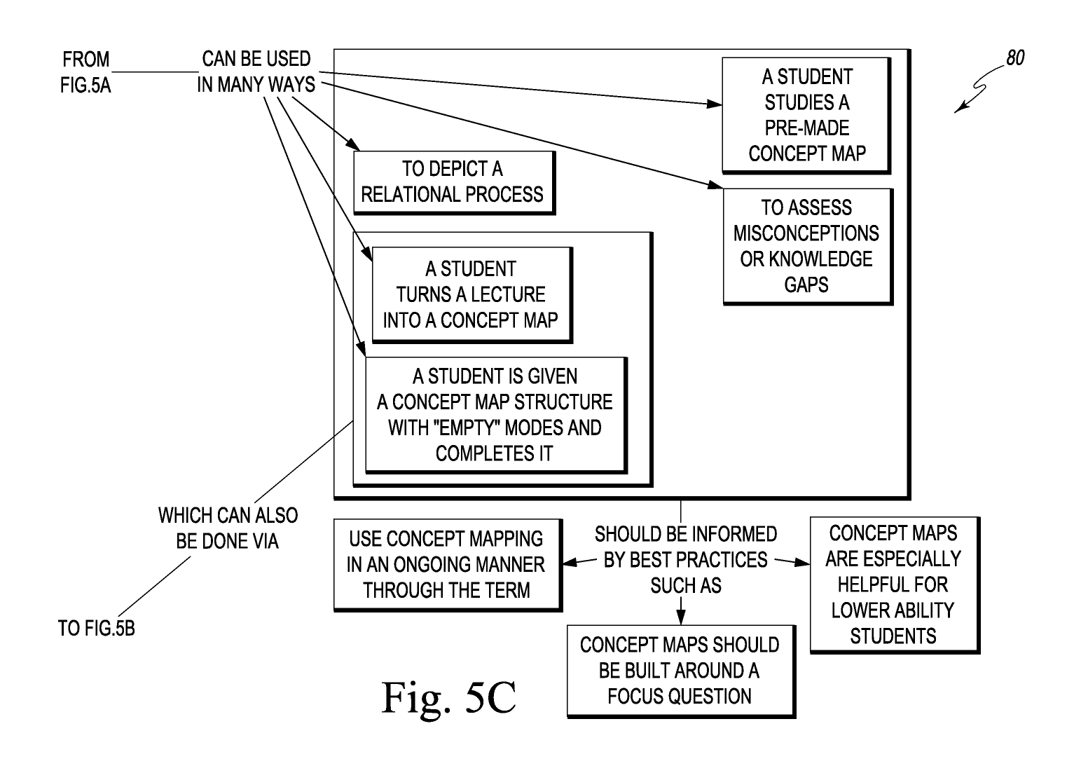

FIGS. 5A, 5B, 5C depict another sample concept map 80. By using clustering and concept mapping the data collected as people use the site, physicians can visually organize and interconnect relationships between similar diagnoses in logical and meaningful ways. Each map serves its own purpose and can be adapted in a variety of ways. This will be the brains of the virtual medical (e.g. spine) specialist. It will not forget to ask an important question because it is not paying attention to you.

The virtual diagnosis procedure or steps can be summed up as follows:

VIPD—>Virtual Doctor Appears—>VIH—>VIPE—>Narrative summary of Symptoms/Signs/History. >SLD Logic: The database grows, patterns are recognized and the VIRTUAL SPINE SPECIALIST learns.

The Internet site 50 will be HIPPA compliant and will not release any (patient specific) medical information about the patient to outside sources. The Internet site will provide a printed copy of the information and data collected to the patient to give to the health care provider. The Internet site is by no means a substitute for a doctor's office visit. This Internet site will be an option for some individuals to reduce health care cost due to the extremely high health care expenses and unnecessary testing/treatments ordered.

Revenue generation is accomplished by administrative fees. The medical advice/information/diagnosis will not cost the individual/patient at all. The revenue from the Internet site will come from an administrative fee charged to the providers that want to receive referrals from the Internet site. The provider will sign a contract with the Internet site. These health care providers will include but are not limited to all types of clinicians/physicians (e.g. PT, chiropractors, medical doctors/nurse practitioners, imaging centers, pharmacies, ECT). They will be graded by the patients they evaluate and treat. This will be disclosed to the patients so they have the choice of selecting a provider and/or pharmacy. Links will be provided to outside provider websites and/or locations based on the patients location to expedite treatment.

The Internet site will also negotiate down charges between similar merchants to drive down cost. The Internet site will provide discount cards for over the counter medications, imaging tests, and physician visits. For example, you likely have arthritis type back pain and the standard treatment is anti-inflammatory medication. You can buy this anti-inflammatory over the counter at pharmacy A or pharmacy B. Our pharmacy B price is 75 cents cheaper. Print and take this discount card with you to receive the best price. As another example, you likely have a herniated disk in your spine and the weakness in you right leg from this problem. Since you symptoms have not responded to therapy and medications for 10 weeks the standard recommendation by the AMA is to obtain an MRI as soon as possible. In your resident State only a chiropractor or medical physician (MD or DO) can legally order an MRI. Since the average emergency visit for treating back pain is $8000 in your region, we recommend you visit an MD or a chiropractor for further evaluation. A “Click Here” link for Recommendations on Evaluation and Management may then be provided. A sample page from the Internet site may include and provide the following:

Recommendation on Evaluation and Management

Option a: See a Chiropractor to Obtain Prescription for MRI Script First

Office Evaluation by:

Dr Jones (Chiropractor) Visit Initial (Free Spine advice) cost=$75

(Includes Free X-Rays if Necessary)

Dr Andrews (Chiropractor) Visit Initial (Free Spine advice) cost=$75

(X-rays not included)

Imaging (MRI) Costs by:

WEST COAST RADIOLOGY: (LUMBAR MRI WITHOUT CONTRAST)=(Free Spine advice) $525

RADIOLOGY PASCO COUNTY: (LUMBAR MRI WITHOUT CONTRAST)=(Free Spine advice) $725

TOTAL COST=$600: Dr Jones+West Coast Radiology to get MRI: (BEST VALUE AND RATINGS)

TOTAL COST=$800: Dr Jones+RADIOLOGY PASCO COUNTY to get MRI:

TOTAL COST=$600: Dr Andrews+West Coast Radiology to get MRI: (BEST VALUE)

TOTAL COST=$800: Dr Andrews+RADIOLOGY PASCO COUNTY to get MRI:

2 Of Choices Above have Equal Value Savings but One Choice has Superior Patient Ratings

Option B: See a Board Certified Spinal Surgeon to Obtain MRI Script First:

Dr Hayes (Orthopedic Surgeon) Initial Visit Free Spine advice cost=$800

Dr French (Neurosurgeon) Initial Visit Free Spine advice cost=$1000

Dr George Neurosurgeon) Initial Visit Free Spine advice cost=$1050

(Includes all x-rays and free sample medication (“Click Here” for more details)

Imaging (MRI) Costs by:

WEST COAST RADIOLOGY: (LUMBAR MRI WITHOUT CONTRAST)=(Free Spine advice) $525

RADIOLOGY PASCO COUNTY: (LUMBAR MRI WITHOUT CONTRAST)=(Free Spine advice) $725

TOTAL COST=$1325: Dr Hayes+West Coast Radiology to get MRI: (BEST VALUE AND RATINGS)

TOTAL COST=$1525: Dr Hayes+RADIOLOGY PASCO COUNTY to get MRI TOTAL COST=$1525: Dr French+West Coast Radiology to get MRI

TOTAL COST=$1725: Dr French+RADIOLOGY PASCO COUNTY to get MRI TOTAL COST=$1575: Dr George+West Coast Radiology to get MRI

TOTAL COST=$1775: Dr George+RADIOLOGY PASCO COUNTY to get MRI

Coupons may thus be another source of revenue for the Internet site. The coupons will be given to patients to save on their health care. These coupons will be printable from the Internet site once the medical diagnosis has been determined. These coupons will be linked to the patient chart (not through name to comply with HIPPA) but through a system such as a bar or Q code system or the like of identification. Once the patient uses the coupon, this will be a way for the company providing the service to track referrals and also to assure that the system has the correct treatment initiated by the company providing feedback regarding the results to the system. The companies will send the results of tests and/or the treatment initiated to the Internet site (system) devoid of patient personal information. This will all be tracked. The requirement to send the patient's treatment results/treatment implemented/test results will be part of the user agreement between the provider and the Internet site such that it is mandatory for the advertised provider to be listed on the Internet site. Providers may pay a monthly fee to be registered on the Internet site or pay a fee based on the number of coupons redeemed or referrals sent. Other schemes may be used.

While the invention has been illustrated and described in detail in the drawings and foregoing description, the same is to be considered as illustrative and not restrictive in character and that all changes and modifications that come within the spirit of the invention are desired to be protected.

All references cited in this specification are incorporated herein by reference to the extent that they supplement, explain, provide a background for or teach methodology or techniques employed herein.

What is claimed is:

1. A system for providing free medical advice via the Internet comprising:
a computer in communication with the Internet; and
an Internet site operating on the computer, the Internet site including:
interactive medical advice logic providing a virtual body on the Internet site that allows a user of the Internet site to identify, for data collection, body parts with respect to a medical condition of the user of the Internet site, and a virtual physician on the Internet site that interacts with the user of the Internet site to collect data regarding the medical condition from the user of the Internet site via questions based on medical data collected from the user of the Internet regarding the medical condition of the user of the Internet site;
medical data interpretation logic providing a free medical diagnosis of the user's medical condition to the user of the Internet site of the user's calculated by a statistical likelihood that the provided medical diagnosis is correct based on the collected medical data from the user of the Internet site and stored medical data collected from other users of the Internet site, and providing the calculated statistical likelihood of the medical diagnosis being; and
medical advice logic providing a free narrative summary of symptoms, signs, history and treatment to the user of the Internet site for the medical condition of the user of the Internet site.

2. The system of claim 1, wherein the medical data interpretation logic includes:
visual pattern recognition logic used by the medical data interpretation logic in calculating the statistical likelihood that the provided medical diagnosis is correct; and
statistical likelihood of diagnosis logic.

3. The system of claim 2, wherein the virtual advice logic provides:
a narrative of symptoms, signs, history of the user of the Internet site; and
treatment options for the provided diagnosis.

4. The system of claim 3, wherein the interactive medical advice logic includes:
virtual interactive pain diagramming logic allowing diagramming of user pain on the virtual body; and
virtual interactive physical examination logic allowing the virtual physician to conduct a virtual physical examination of the user of the Internet site via the virtual body.

5. The system of claim 4, wherein the Internet site further includes:
treatment option logic providing treatment options for the provided diagnosis.

6. The system of claim 5, wherein the treatment option logic includes:
discount coupons for the treatment options.

7. The system of claim 1, wherein the narrative summary is provided in laymen's terms.

8. The system of claim 1, wherein the interactive medical advice logic provides a rotating virtual body.

9. A system for providing free medical advice via the Internet comprising:
a computer in communication with the Internet; and
an Internet site operating on the computer, the Internet site including:
interactive medical advice logic providing a rotatable virtual body on the Internet site that allows a user of the Internet site to identify, for data collection, parts of the virtual body with respect to a medical condition of the user of the Internet site, and a virtual physician on the Internet site that interacts with the user of the Internet site via text and audio to collect data regarding the medical condition from the user of the Internet site via questions based on medical data collected from the user of the Internet regarding the medical condition of the user of the Internet site and medical data collected from past users of the Internet site;
medical data interpretation logic providing a free medical diagnosis of the user's medical condition to the user of the Internet site of the user's calculated by a statistical likelihood that the provided medical diagnosis is correct based on the collected medical data from the user of the Internet site and stored medical data collected from other users of the Internet site, and providing the calculated statistical likelihood of the medical diagnosis being; and
medical advice logic providing a free narrative summary of symptoms, signs, history and treatment to the user of the Internet site for the medical condition of the user of the Internet site.

10. The system of claim 9, wherein the medical data interpretation logic includes:
visual pattern recognition logic used by the medical data interpretation logic in calculating the statistical likelihood that the provided medical diagnosis is correct; and
statistical likelihood of diagnosis logic.

11. The system of claim 10, wherein the virtual advice logic provides:
a narrative of symptoms, signs, history of the user of the Internet site; and
treatment options for the provided diagnosis.

12. The system of claim 11, wherein the interactive medical advice logic includes:
virtual interactive pain diagramming logic allowing diagramming of user pain on the virtual body; and
virtual interactive physical examination logic allowing the virtual physician to conduct a virtual physical examination of the user of the Internet site via the virtual body.

13. The system of claim 12, wherein the Internet site further includes:
treatment option logic providing treatment options for the provided diagnosis.

14. The system of claim 13, wherein the treatment option logic includes:
discount coupons for the treatment options.

15. The system of claim 9, wherein the narrative summary is provided in laymen's terms.
